(19) United States
(12) Patent Application Publication
(10) Pub. No.: US 2010/0058020 A1
(43) Pub. Date: Mar. 4, 2010

(54) MOBILE PHONE AND METHOD FOR MANAGING MEMORY OF THE MOBILE PHONE

(75) Inventor: SHAO-HUNG CHEN, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: CHI MEI COMMUNICATION SYSTEMS, INC., Tu-Cheng City (TW)

(21) Appl. No.: 12/485,850

(22) Filed: Jun. 16, 2009

(30) Foreign Application Priority Data
Aug. 28, 2008 (CN) 200810304274.4

(51) Int. Cl. G06F 12/02

(52) U.S. Cl. 711/170; 711/E12.002

(57) ABSTRACT

A method for managing memory of a mobile phone provides a memory allocation table for images captured by a camera module of the mobile phone. The memory allocation table records memory allocation information of the images. All application programs of the mobile phone can load the image in one memory space allocated for the image according to the memory allocation information in the memory allocation table.

### BACKGROUND

1. Technical Field

Embodiments of the present disclosure relate to memory management methods, and more particularly to a mobile phone and a method for managing memory of a mobile phone.

2. Description of Related Art

At present, a mobile phone needs to provide enough memory space for storing images. If more than one application program requests to load an image at the same time, the mobile phone has to allocate more memory space for respectively storing the image for each of the application programs. As a result, too much memory space of the mobile phone will be used.

Therefore, an effective method for managing memory of a mobile phone is desired to overcome the above-described shortcomings.

### BRIEF DESCRIPTION OF THE DRAWINGS

FIG. 1 is a block diagram of one embodiment of a mobile phone.

FIG. 2 is one embodiment of a memory allocation table of the mobile phone in FIG. 1.

FIG. 3 is a flowchart of one embodiment of a method for managing memory of the mobile phone.

FIG. 4 is a flowchart of one embodiment of a detailed description of block S33 in FIG. 3.

FIG. 5 is a flowchart of one embodiment of a detailed description of block S35 in FIG. 3.

FIG. 6 is a flowchart of one embodiment of a detailed description of block S37 in FIG. 3.

### DETAILED DESCRIPTION

All of the processes described below may be embodied in, and fully automated via, functional modules executed by one or more general purpose processors. The functional modules may be stored in any type of computer-readable medium or other computer storage device. Some or all of the methods may alternatively be embodied in specialized computer hardware or communication apparatus.

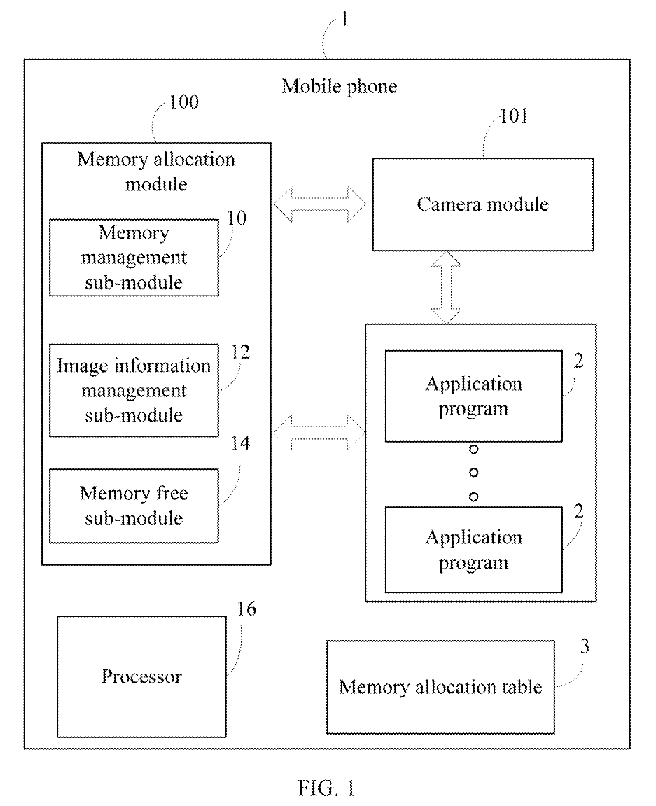

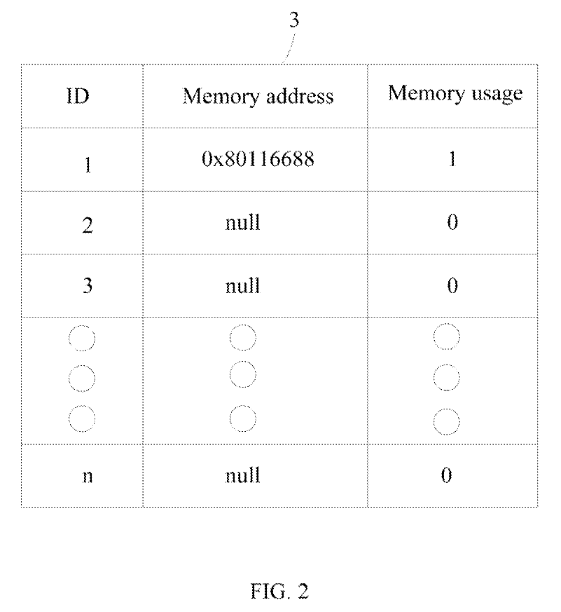

FIG. 1 is a block diagram of one embodiment of a mobile phone 1. In one embodiment, the mobile phone 1 includes a memory allocation module 100, a camera module 101, at least one application program 2 and a memory allocation table 3. The camera module 101 is used to capture images. The at least one application program 2 may be a multimedia messaging service (MMS) program. When the camera module 101 captures an image, the memory allocation module 100 allocates memory space of the mobile phone 1 for the image and writes memory allocation information of the image in the memory allocation table 3. In one embodiment, as shown in FIG. 2, the memory allocation table 3 includes a plurality of identifier (ID) columns for recording memory address and memory space usage information of a plurality of images. It may be understood that the ID of each ID column is stored in metadata of a corresponding image, and that the memory space usage information in each ID column indicates usage times of the corresponding image stored in memory space corresponding to the memory address. In one embodiment, the memory allocation table 3 records allocation information of all memory space of the mobile phone 1. When the memory allocation table 3 is full it means that the mobile phone 1 has no empty memory space allocable.

The mobile phone 1 further includes one or more specialized or general purpose processors, such as a processor 16 to execute computerized codes of the memory allocation module 100, the camera module 101, and the at least one application program 2 to perform certain functions for the mobile phone 1. In one embodiment, the memory allocation module 100 includes a memory management sub-module 10, an image information management sub-module 12, and a memory free sub-module 14.

The memory management sub-module 10 searches if there is any empty ID column in the memory allocation table 3 when the camera module 101 captures an image. If the memory allocation table 3 is full, the memory management sub-module 10 signals the camera module 101 that there is no memory space to be allocated for the image. If there is an empty ID column in the memory allocation table 3, the memory management sub-module 10 allocates memory space for the image and writes memory allocation information of the image in the memory allocation table 3. For example, if memory address of memory space allocated to the image is 0x80116688, the memory management sub-module 10 may write “0x80116688” into the memory address of an ID column “1” of the memory allocation table 3. The memory management sub-module 10 sets an initial value of the memory usage as zero.

The image information management sub-module 12 receives a load image file request and the ID of the image file from an application program 2 of the mobile phone 1. After receiving the load image file request and the ID of the image, the image information management sub-module 12 detects if the ID column corresponding to the ID is empty. If the ID column corresponding to the ID is empty, the image information management sub-module 12 signals the application program 2 that the image does not exist in the memory of the mobile phone 1. If the ID column corresponding to the ID is not empty, the image information management sub-module 12 increases the value of the memory usage of the image by one correspondingly. The image information management sub-module 12 sends the memory address retrieved from the ID column to the application program 2, so that the application program 2 can obtain the image from the memory space of the mobile phone 1 according to the memory address.

The memory free sub-module 14 receives a freeing memory space request and the ID of the image from an application program 2 (such as the MMS program). For example, if the MMS program has sent the picture successfully, the MMS program sends a freeing memory space request and the ID of the image to the memory free sub-module 14. The memory free sub-module 14 also detects if the ID column corresponding to the ID of the image is empty. If the ID column corresponding to the ID of the image is empty, the memory free sub-module 14 signals the MMS program that the memory space of the image has been freed. If the ID column corresponding to the ID of the image is not empty, the memory free sub-module 14 detects if the memory usage of the image in the ID column is zero. If the memory usage of the image in the ID column is zero, the memory free sub-module 14 clears the ID column and releases the memory space with the image. If the memory usage of the image in the ID column is not zero, the memory free sub-module 14 decreases the value of the memory usage of the image by one in the ID column.

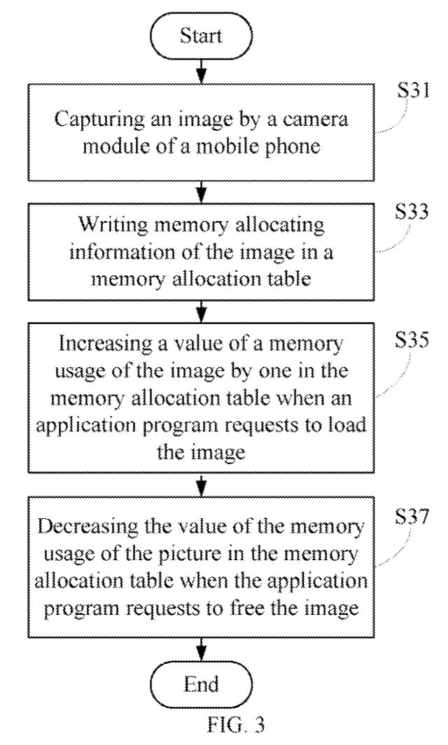

FIG. 3 is a flowchart of one embodiment of a method for managing memory of a mobile phone. In block S31, the camera module 101 captures an image.

In block S33, the memory management sub-module 10 writes memory allocation information of the image in the memory allocation table 3.

When an application program 2 sends a load image file request, in block S35, the image information management sub-module 12 increases the value in the memory usage of the image by one in the memory allocation table 3.

When an application program 2 sends a freeing memory space request of the image, in block S37, the memory free sub-module 14 decreases the value of the memory usage by one of the image.

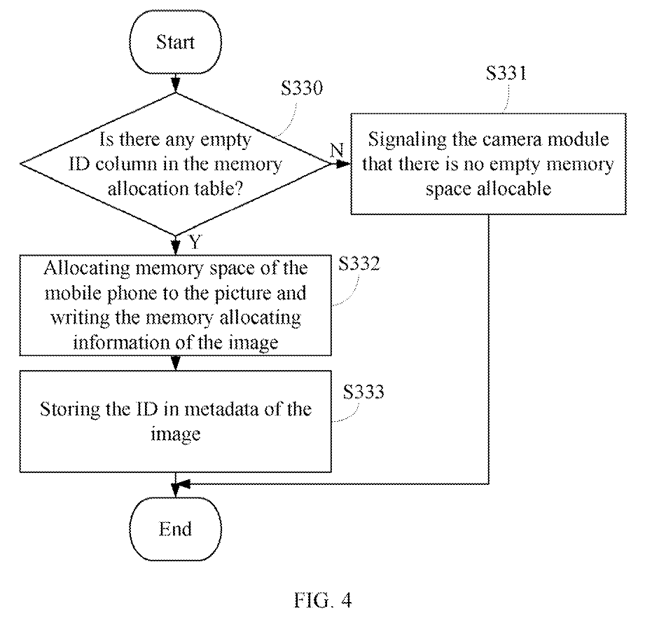

FIG. 4 is a flowchart of one embodiment of a detailed description of the block S33 in FIG. 3. In block S330, the memory management sub-module 10 searches if there is any empty ID column in the memory allocation table 3. If the memory allocation table 3 is full, in block S331, the memory management sub-module 10 signals the camera module 101 that there is no empty memory space to be allocated for the image. If there is an empty ID column in the memory allocation table 3, the procedure goes to block S332.

In block S332, the memory management sub-module 10 allocates memory space of the mobile phone 1 to the image and writes the memory allocation information of the image in the memory allocation table 3.

In block S333, the memory management sub-module 10 stores the ID of the image in metadata of the image.

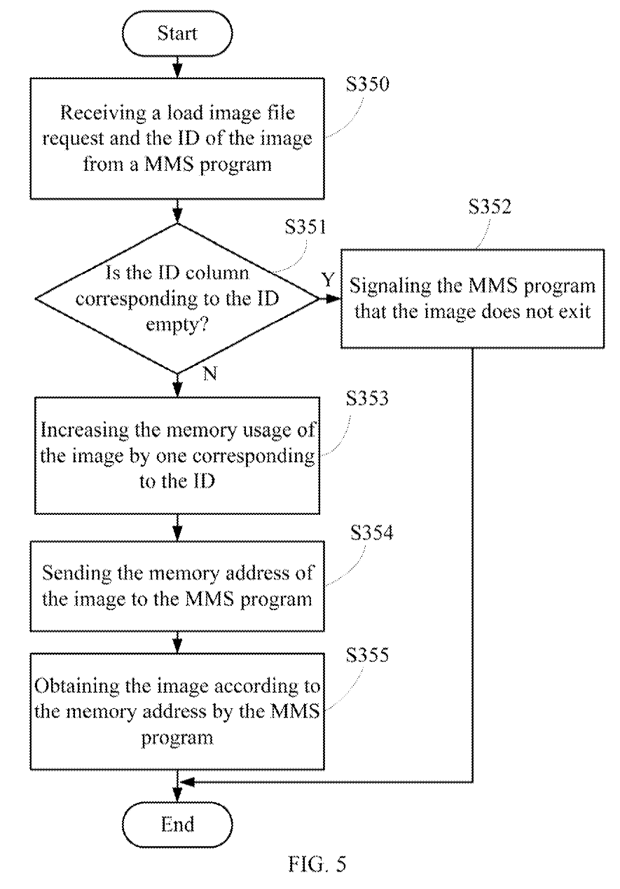

FIG. 5 is a flowchart of one embodiment of a detailed description of block S35 in FIG. 3. In block S350, the image information management sub-module 12 receives a load image file request and the ID of the image from the MMS program.

In block S351, the image information management sub-module 12 detects if the ID column corresponding to the received ID in the memory allocation table 3 is empty. If the ID column in the memory allocation table 3 is empty, in block S352, the image information management sub-module 12 signals the MMS program that the image does not exit in the memory space of the mobile phone 1. If the ID column in the memory allocation table 3 is not empty, the procedure goes to block S353.

In block S353, the image information management sub-module 12 increases the value in the memory usage of the image by one corresponding to the received ID in the memory allocation table 3.

In block S354, the image information management sub-module 12 sends the memory address retrieved from the ID column to the MMS program.

In block S355, the MMS program obtains the image according to the memory address.

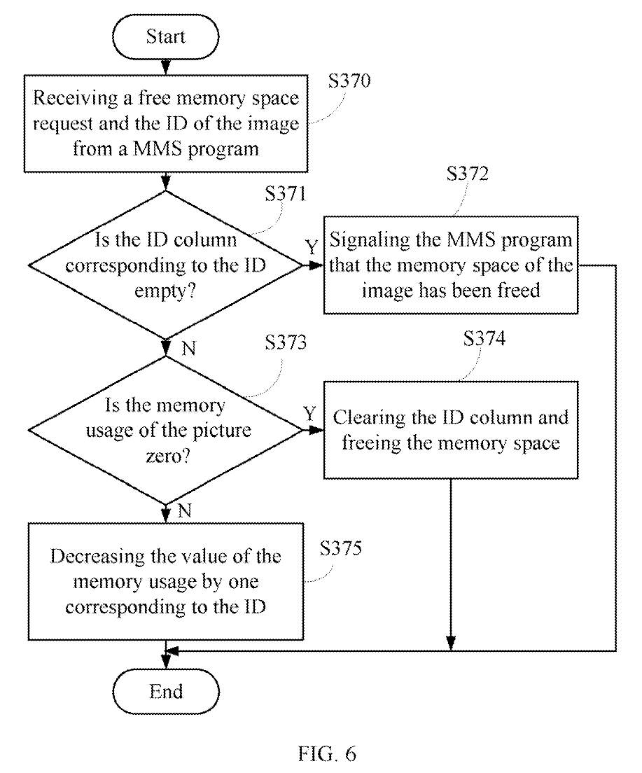

FIG. 6 is a flowchart of one embodiment of a detailed description of block S37 in FIG. 3. In block S370, the memory free sub-module 14 receives a freeing memory space request of the image and the ID of the image sent from the MMS program.

In block S371, the memory free sub-module 14 detects if the ID column corresponding to the ID in the memory allocation table 3 is empty. If the ID column corresponding to the ID is empty, in block S372, the memory free sub-module 14 signals the MMS program that the memory space of the image has been freed. If the ID column corresponding to the ID is not empty, the procedure goes to block S373.

In block S373, the memory free sub-module 14 detects if the memory usage in the memory allocation table 3 corresponding to the ID is zero. If the memory usage corresponding to the ID is zero, in block S374, the memory free sub-module 14 clears the ID column and releases the memory space with the image. If the memory usage of the image in the ID column is not zero, the procedure goes to block S375.

In block S375, the memory free sub-module 14 decreases the value of the memory usage of the image by one in the ID column.

The above embodiments provide a memory allocation table 3 in the mobile phone 1. ID columns in the memory allocation table 3 reflect allocation information of all memory space of the mobile phone 1. When the camera module 101 captures an image, memory space is allocated to store the image and memory space allocation information is recorded in an ID column of the memory allocation table 3. When a plurality of application programs 2 request to access the image, the mobile phone 1 does not need to allocate memory space to store the image for each of the plurality of the application programs 2. All the application programs 2 can access the image from the single allocated memory space. If an image has not been loaded by any one application programs 2, the memory allocation module 100 will release the memory space of the image.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. A mobile phone, comprising:
a camera module to capture an image;
at least one processor; and
a memory allocation module executed by the at least one processor, the memory allocation module comprising:
a memory management sub-module to write memory allocation information of the image in a memory allocation table of the mobile phone, the memory allocation information comprising an identification (ID), a memory address, and memory usage of the image;
an image information management sub-module to receive a load image file request and the ID of the image from an application program of the mobile phone, and to increase a value of the memory usage by one if an ID column corresponding to the ID is not empty; and
a memory free sub-module to receive a freeing memory space request of the image and the ID of the image from the application program, and to decrease the value of the memory usage by one corresponding to the ID if an ID column corresponding to the ID is not empty and the memory usage of the image is not zero.

2. The mobile phone of claim 1, wherein the memory management sub-module further signals the camera module that there is no empty memory space to be allocated to the image, and to allocate memory space of the mobile phone to the image if there is empty ID column in the memory allocation table.

3. The mobile phone of claim 1, wherein the image information management sub-module further signals the application program that the image which the application program requests to load does not exit in the memory space if the ID column corresponding to the ID is empty.

4. The mobile phone of claim 1, wherein the memory release sub-module further signals the application program that the memory space of the image has been freed if the ID column corresponding to the ID is empty, and to clear the ID column and free the memory space if the ID column is not empty and the memory usage of the image is zero.

5. A method for managing memory of a mobile phone, the method comprising:
(a) capturing an image by a camera module of the mobile phone;
(b) writing memory allocation information of the image in a memory allocation table of the mobile phone, the memory allocation information comprising an identification (ID), a memory address, and memory usage of the image;
(c) receiving a load image file request and the ID of the image from an application program of the mobile phone, and increasing a value of the memory usage by one if an ID column corresponding to the ID is not empty; and
(d) receiving a freeing memory space request of the image and the ID of the image from the application program, and decreasing the value of the memory usage by one corresponding to the ID if an ID column corresponding to the ID is not empty and the memory usage of the image is not zero.

6. The method of claim 5, wherein block (b) comprises:
searching if there is any empty ID column in the memory allocation table;
signaling the camera module that there is no empty memory space to be allocated for the image; and
allocating memory space of the mobile phone to the image if there is empty ID column in the memory allocation table.

7. The method of claim 5, wherein block (c) comprises:
signaling the application program that the image which the application program requests to load does not exit in the memory space if the ID column corresponding to the ID is empty.

8. The method of claim 5, wherein block (d) comprises:
signaling the application program that the memory space of the image has been freed if the ID column corresponding to the ID is empty; and
clearing the ID column and freeing the memory space if the ID column is not empty and the memory usage of the image is zero.

9. A computer-readable medium having stored therein instructions that, when executed by a mobile phone with a camera module, cause the mobile phone to perform a method for managing memory of a mobile phone, the method comprising:
(a) capturing an image by a camera module of the mobile phone;
(b) writing memory allocation information of the image in a memory allocation table of the mobile phone, the memory allocation information comprising an identification (ID), a memory address, and memory usage of the image;
(c) receiving a load image file request and the ID of the image from an application program of the mobile phone, and increasing a value of the memory usage by one if an ID column corresponding to the ID is not empty; and
(d) receiving a freeing memory space request of the image and the ID of the image from the application program, and decreasing the value of the memory usage by one corresponding to the ID if an ID column corresponding to the ID is not empty and the memory usage of the image is not zero.

10. The medium of claim 9, wherein block (b) comprises:
searching if there is any empty ID column in the memory allocation table;
signaling the camera module that there is no empty memory space to be allocated for the image; and
allocating memory space of the mobile phone to the image if there is empty ID column in the memory allocation table.

11. The medium of claim 9, wherein block (c) comprises:
signaling the application program that the image which the application program requests to load does not exit in the memory space if the ID column corresponding to the ID is empty.

12. The medium of claim 9, wherein block (d) comprises:
signaling the application program that the memory space of the image has been freed if the ID column corresponding to the ID is empty; and
clearing the ID column and freeing the memory space if the ID column is not empty and the memory usage of the image is zero.
